(19) United States
(12) Patent Application Publication
(10) Pub. No.: US 2007/0061888 A1
(43) Pub. Date: Mar. 15, 2007

(54) Optical disc registration system

(76) Inventor: Richard H. Selinfreund, Terre Haute, IN (US)

Correspondence Address: KELLEY DRYE & WARREN LLP, TWO STAMFORD PLAZA, 281 TRESSER BOULEVARD, STAMFORD, CT, 06901, US

(21) Appl. No.: 11/398,452

(22) Filed: Apr. 5, 2006

Related U.S. Application Data
(60) Provisional application No. 60/668,262, filed on Apr. 5, 2005.

(51) Int. Cl. H04N 7/16

(52) U.S. Cl. 726/26

(57) ABSTRACT

An optical medium registration system locking an optical medium, having a unique code comprising optically-readable indicia therein, to the processing device upon which it is to be read.

### RELATED APPLICATIONS

This application claims priority to U.S. Provisional Patent Application No. 60/668,262, filed Apr. 5, 2005.

### BACKGROUND OF THE INVENTION

1. Field of the Invention

The present invention generally relates to an optical medium registration system that locks the optical medium to the processing device upon which it is read.

2. Description of the Related Art

The development of software and other forms of content data, such as visual and auditory digital data, represents a large investment in time and money. Such content data is generally stored on a transportable storage medium which is then sold to a purchaser. Unfortunately, the unauthorized use and copying of content data from transportable storage media is typically very easy, requiring little time and little investment. External storage of the content data from the transportable data storage medium is often simple and allows for storage of the content data on multiple processing machines.

There have been numerous attempts to curb content data piracy. Some of such attempts are described below.

In one approach, a serial number is placed in the content data to allow for tracing of unauthorized copies of the serialized content data. The problem with this method is that it requires the task of external enforcement to track down illegal copies. Further, hackers of a number of such systems have found it relatively easy to locate and erase the serial numbers.

In another approach, a hardware key containing code is used that matches the serial number for a particular content medium. A software program, either on the key or the computer, prohibits the content medium to be run or to be read on a computer unless the matching key is inserted into a port of the computer. The problem with this approach is that both the key and the disk are transferable to other machines.

In yet another approach, a code identifying a particular processor upon which the transportable data storage medium is processed is stored on the transportable data storage medium in a software program on the transportable data storage medium that prohibits use of the transportable data storage medium unless the code on the medium subsequently matches the code stored in the machine. U.S. Pat. No. 4,688,169 to Joshi, for example, describes such a system wherein the machine identification code unique to the machine is retrieved and compared with the machine identification code in a program, and execution of the program is denied unless both codes are present and match.

In yet another approach, described in U.S. Pat. No. 5,113,518 to Durst Jr., et al., characteristics of the computer system on which an application program is to be employed, such as bus size, computer clock speed, cyclic redundancy of ROM, random-access-memory wait states, disk drive rotation speed, read/write head access speed, and hard disk interleave value, are measured upon inserting the application program into the computer system and then stored in the application program. When the application program is sought to be executed, the program re-determines the characteristics of the computer system and compares against the stored values.

In U.S. Pat. No. 5,490,216 to Richardson, there is described a registration system that allows digital data or software to run in a use mode on a platform if and only if an appropriate licensing procedure has been followed. In one embodiment, a unique identifier is generated locally, and the algorithm used to generate the local unique ID is replicated remotely for the purposes of generating a separate unique ID for matching purposes. The unique identifier is based at least in part upon information supplied by the user that characterizes the user.

The registration systems described above may be used with respect to any number of transportable content storage mediums available, such as magnetic floppy disks, magnetic tapes, and optical discs. A problem with many of the registration systems of the prior art is that they require digital data codes to be applied to the transportable content storage mediums to effectuate their locking to one or more computer systems. These codes, which may be readable by a reader, unfortunately may be easily circumvented by hackers by alteration of the detected code at the sectors or locations upon which it is stored.

There is need for improved systems for restricting access to content stored on a transportable data storage medium to the processing system(s) upon which it is authorized to be used.

### Definitions

“Indicia”: a distinguishable mark, object, or indicator purposefully placed on an item in order to indicate a state.

“Near-field Optics”: employs use of a light source configured to emit electromagnetic wavelengths that are smaller than the wavelength of light, such wavelengths being used to illuminate and detect objects whose distance from the light sources is also less than a wavelength. Near-field optics allows for the detection of the interaction between an optical field and matter in the nanometric region. Near-field optics exploit evanescent as well as propagating light fields. Near-field optics can be used to break the resolution limit in x, y, z of typical lens based optics by sending light through an aperture that is much smaller than the wavelength of light and then scanning the aperture or the sample relative to each other at a distance much smaller than a wavelength.

“Optically-readable Indicia”: indicia that are detectable by an Optical Reader.

“Optical Medium”: a medium of any geometric shape (not necessarily circular) that is capable of storing indicia or content that may be read by an optical reader.

“Optical Reader”: a Reader (as defined below)for the reading of optical medium.

“Reader”: any device capable of detecting indicia that has been recorded on an optical medium. By the term “reader” it is meant to include, without limitation, a player. Examples are CD and DVD readers.

“Recording Layers”: one or more layers of an optical medium where indicia or content is recorded for reading, playing or uploading to a computer. Such content may include, without limitation, software programs, software data, audio tiles and video files.

“Three-dimensional Optical Recording Medium”: an optical medium permitting storage of indicia or content in more than one plane or recording layer on an optical medium.

For the purpose of the rest of the disclosure, it is understood that the terms as defined above are intended whether such terms are in all initial cap, or not.

### SUMMARY OF THE INVENTION

The present invention provides in one embodiment for a method of registering an optical medium with a processing system.

In one embodiment, a unique code is placed in one or more planes, one or more, or two or more, of which may constitute a recording layer, in a three-dimensional optical recording medium. The unique code may be associated, for example, with a processing system and/or user. If the three-dimensional optical recording medium is a transportable content storage medium, the unique code may be generated before delivery of the optical medium to the user, or after delivery as by way of an algorithm subsequently run on the processing system to generate a unique code on the medium. The unique code may be based in whole or in part, for example, on parameters of the operating system (such as, for example, bus size, computer clock speed, cyclic redundancy of ROM, random-access-memory wait states, or interleave value) and/or data supplied by the user, such as, for example, user responses to a set of questions or personal information provided by the user, and/or may be generated using other non-system/non-user related data, such as taking into account the time and date of production of the three-dimensional optical recording medium.

In yet another embodiment, the reader of the three-dimensional optical recording medium makes use of near-field optics, and the three-dimensional optical recording medium stores indicia and/or data in or on at least one recording layer that is readable by a near-field optical system but not a standard lens based system. In such embodiment, data storage can be greatly enhanced, allowing for example about a terabyte (about 1024 gigabytes or roughly 10¹² bytes) of data to be stored on one three-dimensional optical recording medium. Given the great number of planes in which the unique code may be written or dispersed, the difficulty of altering the unique code, or determining the same from read of the data is greatly enhanced. The unique code may be represented by indicia/data in one or more recording layer(s), indicia outside of the recording layers, and/or indicia outside of one or more recording layers.

In another embodiment, one or more materials, for example dyes, are placed into an optical medium in a manner to correlate to the system or user to which the optical medium relates. The materials may be uniquely placed according to the system or user, and/or special materials may be placed in non-unique positions which may be particularly related to the system or user authorized to use the optical medium.

In another embodiment, one or more errors, or non-configurable or non-changeable data reads (that is, “permanent read states “), are introduced into, or are inherent in, the medium and correspond to at least a portion of the unique code. Such permanent read states may be placed into an optical medium having multiple recording layers, such as a 3-dimensional optical medium. The individual manufacturing differences in each medium may be mapped to provide at least a portion of the unique code on the disc. The differences provide for the authentication and locking internal to each disc.

The optical medium may be in disc form having, for example, the same, or about the same, diameter and thickness and relative weight of current CD/DVD discs. This may allow for use of a single read/write laser head similar to the optical pick-up units of current CDs/DVDs. The far-field optics configuration of present CD/DVD optical assemblies found on optical readers may be exchanged for near-field read/write configurations. This would allow for very narrow depth of read/write focus allowing more data to be stored per unit area of optical media, and would protect against cross talk between optical recording layers when writing/reading optical data.

In yet another embodiment, there is disclosed a registration system for licensing execution of content data in a use mode, the content data being used on a platform, the system including a unique ID recorded onto a multi-recording layer optical medium, a mode switching system that permits use of the content data when the unique ID recorded onto the multi-recording layer optical medium has matched a unique ID known to the platform. The platform may be a processor, such as a computer. The multi-recording layer optical medium may be a three-dimensional optical recording medium. The unique ID may be stored in one or more recording layer, and/or outside of said recording layer(s). The mode switching system may comprise a software program. The unique ID may be calculated using input related to the user of the system and/or user response to a series of questions and/or computer operation parameters and/or input unrelated to the system or user.

### DETAILED DESCRIPTION OF THE INVENTION

The present invention provides for a content registration system for securing data transmission and storage of information.

In one embodiment, a unique code or key is formed in the optical medium comprising one or more indicia that may be representative of digital data. The indicia may be formed in one recording layer, or may be dispersed among different recording layers, or in one or more planes within the optical medium. The indicia may comprise one or more materials different from the material (such as polycarbonate) comprising the bulk of the optical medium, and/or may comprise one or more deformations or aberrations in the optical medium, which deformations or aberrations may result in one or more data error states. The unique code or key may be more effectively dispersed on the optical medium when the code or key is stored on a multi-recording layer optical medium, in particular a 3-dimensional optical medium. The indicia should be of such size and character to cause a detectable datum or optical dis-uniformity in the optical medium by an optical reader.

In one embodiment, the unique code or key is generated before shipment of the optical medium to a user. Such code may be based in part on user provided information regarding the processing system on which it is to be encrypted.

In one embodiment, the optical medium contains a software program that causes a download of the code or key, or a related code or key associable with the code or key of the optical medium, onto a processor that is configured to use the content stored on the optical medium. Alternatively, the software program for locking the processor to the disc may reside on the processor itself and may cause the processor to store the code or key located on the optical medium (or an associated code or key therewith) on the processor. Alternatively the software program that causes the processor to store the unique code or key of the optical medium, or associated code or key therewith, is located on another device that is operatively associated with the processor or optical medium.

Further embodiments include the code for causing a check of a match between the unique code or key on the optical medium and the key or code on the processor. Such code may be found on either the optical medium, the processor, a device operatively associated with the processor or optical medium, or a remote device to either or both the processor and the optical medium.

In another embodiment the unique code or key is generated after manufacture of the optical medium by selective recording of indicia onto the medium. The selective recordation may occur under the influence of a program instruction set stored on the optical medium, the processor, or a device remote to the processor and/or optical medium. For example, the unique code or key on the optical medium may be generated after first installation into a processor.

The unique code or key may be based, for example, at least in part on the parametric configuration of the processor onto which the optical medium is first installed, for example, based on such values as of the interleave value or data processing speed. The unique code or key stored on the optical recording medium may be based, for example, at least in part upon input provided by the intended user of the content stored on the optical medium. For example, the intended user may provide personal information, or response to select questions that may be used to identify the user, and this datum can be used to generate the unique code or key. The code or key on the optical medium may be based on a processor code or key associated with the processor, either at time of the processor's manufacture, or subsequent to the processor's manufacture.

The optical medium containing, or to contain, the code or key, which may be unique, may be made within a three-dimensional optical recording medium. In such medium, the code or key can be dispersed along one or more planes of the disc, providing enhanced security.

Indicia may be made within the optical medium by including within the optical medium materials sensitive to certain electromagnetic emissions, such as light wavelengths, or near-field wavelengths smaller the wavelength of light. Such materials include optical state change materials that may be organic or inorganic. The indicia may be designed to allow for read of the indicia by electromagnetic emissions produced by the optical reader upon which the optical medium is to be placed, for example, far-field or near-field electromagnet emissions. Three-dimensional fabrication of indicia may be caused by a conversion of the optical state of the material or by an interaction of one material in the optical medium with another material in the optical medium. For example, two-photon absorption (TPA) may be used to confine photochemical and physical reactions, such as photopolymerization, to the order of laser wavelength in three dimensions. TPA may, for example, be undertaken using a mode-locked Ti:Sapphire laser (780 nm, 82 MHz, 80 fs) focused through an objective lens (N.A.=1.4), and the emitted electromagnetic radiation may, by altering the focal point, produce three-dimensional indicia structures. Indicia may be written for example on PMMA.

Code or key indicia may be associated and/or disassociated from content indicia. Content indicia are indicia that comprise the actual content that is stored on the optical medium for use through an optical reader. Content indicia may be stored in one or more recording layers, or in one or more planes of an optical medium. When multiple recording layers are encompassed within the optical medium, more content data can be stored on the optical medium. When the optical medium comprises a three-dimensional optical medium having multiple data storage planes, the increase in storage may be significantly enhanced over an optical medium storing data only on its surface layer. When near-field optics are used to read a three-dimensional optical medium, the optical medium may have far more recording layers than when far-field optics are used to read the medium.

The indicia comprising the key or code may comprise one or more errors that may be introduced during the manufacture of the optical medium, or introduced after the manufacture of the optical medium. Errors may be introduced, in one embodiment, when the optical medium is placed into an optical reader interfaced to a processor. The code or key indicia can then be used for authentication and locking internal to each optical medium, such as an optical disc.

In one embodiment, there is disclosed a registration system for licensing execution of content data in a use mode, the content data being used on a platform, the system including a unique ID comprising a plurality of optically-detectable indicia recorded onto a multi-recording layer optical medium, a mode switching system that permits use of the content data when the unique ID recorded onto the multi-recording layer optical medium has matched, or is correlatable to, a unique ID known to the platform. The unique ID may become known to the platform by either input provided from the optical medium itself, or from data provided from a remote source. Optionally the mode switching system may permit operation of the content data, such as digital data, in the use mode in subsequent execution of the content data only if the unique ID of the optical medium matches in some defined manner, or is otherwise correlatable to, the unique ID known to the platform, and the platform unique ID has not changed (or changed in an appreciable manner).

The registration system optionally may check at the time of boot read of the content as to whether it is a first read of the content or a subsequent boot read. If a subsequent boot read is detected, the environment and user details may be used to determine whether the program reverts to a demonstration mode, or a new user registration procedure is commenced to run a full version, or full read capability is given.

The platform unique ID, or optical medium unique ID, may be based in whole or in part on platform configuration information. The platform unique ID generated, or optical medium unique ID, may be based upon information input provided to the platform, such information input which may be by way of the user, and may relate to the user, platform, or other verifiable information.

The uniquely identified optical media may also be used in a system and method to control the distribution of content data such as software. The system and method may utilize a mode-switching system associated with the content that is adapted to switch said content between a fully enabled mode and a partly enabled or demonstration mode. The system and method may make use of a registration key generator adapted to generate a registration key which is a function of information identifying the intended user of the content. The mode-switching system may switch upon input into the fully-enabled mode only upon input of an enabling key at the time of registration of the optical medium. Such enabling key may be generated by the processor upon which the optical medium is read or by a remote processor, for example, which has a copy of the registration key generator. The mode-switching system and registration key generator may comprise a software instruction set.

Materials that may be used in such system for causing optical indicia include dyes. Dyes useful in the system include recording dyes used in optical storage media presently. By choosing selective dye systems, the dyes may be mixed directly into the optical storage component polymer without degradation due to molding pressures and temperature accompanying pelletization and subsequent formation of the optical medium, for example, optical disc. Such may pose an advance over presently available recording dyes that are spin or sputter coated over the optical substrates. For example, methylene blue cross linked to HEMA may be directly added to the optical storage component polymer, such as polycarbonate, and made into a disc without degradation of the dye.

### EXAMPLE

Five grams of methylene blue may be added to 25 grams of HEMA in 250 milliliters of methoxypropanol. Cross-linking to form HEMA-propylene blue may be effectuated over 24 hours and may take cross-linking reagents.

Ten milliliters of stock HEMA-propylene blue cross-linked solution is added to 490 milliliters of methoxypropanol. Four hundred ninety melted polycarbonate pellets are then added, and the pellet solution is stirred overnight until the methoxypropanol is evaporated. The dye-polycarbonate mixture is pelletized using standard polycarbonate pellet formation equipment, for example, manufactured by GE-Plastics, Tashjian Plastics or Bayer Plastics. The pellets may be used the next day to form discs.

Optical storage medium of the present invention may comprise games, video, audio, software programs, keys, and other content. The optical medium, which may comprise HD-DVD or Blue-Ray technology, may be associated with one or more of a number of processors operatively configured to read such medium, including, for example, a cell phone system using an optical medium (wherein the optical medium can be used to lock the cell phone) and in serialized optical components for telecommunications. Mass data storage with optical locking can be eventuated from use of 3-dimensional optical media.

The materials comprising the optically-detectable indicia may retain their optical state in a non-transient manner. That is, after activation, the materials may retain their activated optical state for a prolonged period of time, if not permanently. By selection of the appropriate materials, the optical state change can be limited to a period of time to allow for a limited use period—that is, after degradation of the change, the key or code is corrupted and the processor can no longer read it.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. A registration system for licensing execution of content data in a use mode, the content data being used on a platform, the system including a unique ID recorded onto a multi-recording layer optical medium, a mode switching system that permits use of the content data when the unique ID recorded onto the multi-recording layer optical medium is correlatable to a unique ID known to the platform.

2. A registration system in accordance with claim 1 wherein the platform comprises a platform processor.

3. A registration system in accordance with claim 2 wherein the platform processor is a computer.

4. A registration system in accordance with claim 1 wherein the multi-recording layer optical medium is a three-dimensional optical recording medium.

5. A registration system in accordance with claim 1 wherein the unique ID of the optical recording medium is stored in one or more recording layers, and/or outside of said recording layer(s).

6. A registration system in accordance with claim 5 wherein the unique ID comprises one or more optical indicia on the optical media.

7. A registration system in accordance with claim 6 wherein the optical indicia are non-configurable or changeable by at least one user of the system.

8. A registration system in accordance with claim 1 wherein the mode switching system comprises a software program.

9. A registration system in accordance with claim 1 wherein the unique ID is calculated using input related to the user of the system.

10. A registration system in accordance with claim 1 wherein the unique ID is calculated using user responses to a series of questions.

11. A registration system in accordance with claim 1 wherein the unique ID is calculated using processor operation parameters of the processor on which the optical medium is to be read.

12. A processor security system for restricting execution of a read of content data stored on an optical recording medium to a particular processor comprising: a processor capable of retrieving a unique key; an optical medium comprising one or more optical indicia therein representative of a unique optical indicia key; a comparator operatively configured to compare the unique key retrieved by the machine with the unique optical indicia key; a read switch mechanism operatively configured to permit read of said content data stored on said optical recording medium if the unique key retrieved by the processor is associated with the unique optical indicia key of the optical medium in a defined manner.

13. A processor security system in accordance with claim 12 wherein the optical indicia comprising said unique optical indicia key is non-configurable or changeable by at least one user of the system.

14. A processor security system in accordance with claim 12 wherein the read switch mechanism is a software instruction set.

15. A processor security system in accordance with claim 12 wherein the read switch mechanism permits read of said content data stored on the optical recording medium when the unique optical indicia key of the optical medium matches the unique key retrieved by the processor.

16. A processor security system in accordance with claim 12 wherein the processor retrieves its unique key from a storage device remote to the processor.

17. A processor security system in accordance with claim 12 wherein the processor retrieves its unique key from a storage device proximal to the processor.

18. A processor security system in accordance with claim 12 wherein the process retrieves its unique key by calculating the key from input.

19. A processor security system in accordance with claim 12 wherein the optical medium comprises a three-dimensional optical recording medium.

20. A processor security system in accordance with claim 12 wherein the unique optical indicia key comprises one or more materials in an optical state distinct from the optical state of the homogenous material of the optical medium.

21. A method for restricting content readable on a processor to a particular processor comprising the steps of: storing a unique key on an optical medium, said unique key comprising one or more optical indicia distinct from the substrate of the optical medium; retrieving a processor identification key unique to said processor; comparing said unique optical medium key with said unique processor identification key; preventing further use of said content unless both keys are present and match.

22. A method in accordance with claim 21 wherein the content is a video and/or audio.
